(19) United States
(12) Patent Application Publication
(10) Pub. No.: US 2026/0080472 A1
(43) Pub. Date: Mar. 19, 2026

(54) SYSTEM AND METHOD FOR ALERTING A USER OF A SOCIAL MEDIA ANOMALY CONCERNING A PUBLICLY TRADED SECURITY USING ONE OR MORE MACHINE LEARNING MODELS

(71) Applicant: Narravance, Inc., Princeton, NJ (US)

(72) Inventors: Adam WASSERMAN, Lincroft, NJ (US); Adam SOHN, Edgewater, MD (US); Pratik RATADIYA, Jersey City, NJ (US)

(21) Appl. No.: 19/331,747

(22) Filed: Sep. 17, 2025

Related U.S. Application Data
(60) Provisional application No. 63/695,650, filed on Sep. 17, 2024.

(51) Int. Cl. G06Q 40/04; G06Q 50/00

(52) U.S. Cl. CPC G06Q 40/042; G06Q 10/40

(57) ABSTRACT

Systems, methods, and computer program products for alerting a user of an anomaly concerning a publicly traded financial product, such as a publicly traded financial security with potentially upcoming volatility, include obtaining online chatter from one or more social media platforms associated with the publicly traded financial product posted over a first time interval, determining, at the end of the first time interval, an anomaly concerning the publicly traded financial product based at least in part on the online chatter associated with the publicly traded financial product, and responsive to determining the anomaly, providing an alert to the user. Determining the anomaly is based at least in part on historical data regarding online chatter associated with the publicly traded financial product from a prior time interval before the first time interval.

### CROSS-REFERENCE TO RELATED APPLICATIONS

This application claims priority to U.S. Provisional Patent Application No. 63/695,650, filed Sep. 17, 2024 and titled SYSTEM AND METHOD FOR CREATING AND PLACING CAUTION BADGES ON SECURITIES, which is hereby incorporated by reference herein in its entirety.

### FIELD OF THE INVENTION

The present invention relates generally to systems, methods, and computer program products for identifying publicly traded securities that are subject to online social media influence, and more particularly, publicly traded securities likely to make significant market movements due to online social media influence.

### BACKGROUND OF THE INVENTION

Short term trading of publicly traded securities (i.e., financial instruments, such as stocks, bonds, and derivatives, that can be bought and sold on an organized marketplace, such as a stock exchange) has long been a central aspect of capital markets, and can be both opportunistic and risky. Investors of all types, including retail traders, institutional investors, portfolio managers, and financial advisors desire timely, accessible, and accurate/trustworthy information to make trading decisions. Existing systems that provide security related information to traders, such as brokerage platforms, market data feeds, and third-party analytics tools, have notable limitations.

In particular, the proliferation of the internet, social media, and now artificial intelligence (AI) has given rise to new forms of information generation and dissemination. These publicly available technologies have spread rapidly, and provide investors with faster access to information and advanced analytics. However, they also create new vulnerabilities. Influencers and other manipulative actors can instantly spread misleading or false information to influence public opinion and trading behavior. Their use of social media and other online platforms amplifies the risk and impact of traditional manipulative schemes, such as pump and dump operations, fabricated press releases/fake news, whisper campaigns, misleading research reports or ratings that lack objectivity (e.g., that are influenced by undisclosed financial relationships), fake online identities (e.g., bots, fake accounts) that give the appearance of investor consensus, and scare tactics such as false claims of lawsuits, bankruptcies, or investigations.

A lack of knowledge and awareness about these types of online activity as they're happening increases the risk of financial harm to investors. While government agencies such as the U.S. Securities and Exchange Commission (SEC) exist to deter, investigate, and punish fraudulent activity in financial markets, investigations and litigations may take years, and often require substantial resources. Many investors who are harmed by fraud never fully recover their losses or receive any meaningful recovery. Thus, despite government oversight, significant challenges remain to ensure that the communication of securities related information is timely and more comprehensive.

### SUMMARY OF THE INVENTION

A first aspect of the invention is a system for alerting a user of an anomaly concerning a publicly traded financial product, comprising one or more processors; and a memory storing instructions that, when executed by the one or more processors, cause the one or more processors to: obtain online chatter from one or more social media platforms associated with the publicly traded financial product posted over a first time interval; determine, at the end of the first time interval, an anomaly concerning the publicly traded financial product based at least in part on the online chatter associated with the publicly traded financial product; and responsive to determining the anomaly, cause an alert to be provided to the user.

In certain embodiments, the processors may be further caused to obtain historical data regarding online chatter associated with the publicly traded financial product from a prior time interval before the first time interval. The determination of the anomaly may be based at least in part on the historical data, and/or at least in part on comparing a number of posts in the online chatter associated with the publicly traded financial product over the first time interval with a threshold determined using the historical data. The threshold may be determined, at least in part, by feeding the historical data into a first machine learning model trained to determine an average and a standard deviation of a number of posts in the online chatter over the prior time interval in the historical data. Determination of the anomaly may be based at least in part on the number of posts in the online chatter associated with the publicly traded financial product over the first time interval exceeding a threshold comprising a sum of the average number of posts and a multiple of the standard deviation.

In certain embodiments, the first time interval may be a period of time during a single trading day, and the determination of the anomaly may be based at least in part on whether the number of posts in the online chatter associated with the publicly traded financial product over the first time interval exceeds, by a predetermined percentage, an average number of posts during a same period of time over a number of previous trading days. Causing an alert to be provided may comprise obtaining metadata regarding the online chatter in the first time interval; feeding the metadata regarding the online chatter in the first time interval into a machine learning model trained to output a prediction whether or not a price of the publicly traded financial product will move more than a predetermined amount based on training data comprising a set of known metadata and known amounts of price movement corresponding to the known metadata; and generating, via the machine learning model, a prediction whether or not a price of the publicly traded financial product will move more than a predetermined amount.

In certain embodiments, the set of known metadata comprises one or more selected from the group consisting of (i) an average number of posts made by each poster every day for a previous number of days, (ii) an average number of followers of each poster at a time when the anomaly is determined, (iii) whether market data for the publicly traded security was available when the anomaly was determined, (iv) a lowest price of the publicly traded financial product during the first time interval, and (v) a difference between a highest price and the lowest price of the publicly traded financial product during the first time interval. The alert may comprise at least one selected from the group comprising a visual alert and an audio alert. Causing the alert to be provided may comprise classifying the anomaly as one of a plurality types of anomaly. The alert may be configured to be indicative of the classification.

In certain embodiments, the processors may be caused to display a graphical user interface. The alert can be displayed alongside market data for the publicly traded security in the graphical user interface. The processors may also feed the online chatter over the first time interval into a large language model trained to provide a summary of online chatter. A summary of the online chatter over the first time interval generated by the large language model can be provided to the user with the alert.

In another aspect of the invention, a method for alerting a user of an anomaly concerning a publicly traded financial product comprises obtaining, with a computer, online chatter from one or more social media platforms associated with the publicly traded security posted over a first time interval; determining, with the computer, at the end of the first time interval, an anomaly concerning the publicly traded financial product based at least in part on the online chatter associated with the publicly traded financial product; and responsive to determining the anomaly, causing, with the computer, an alert to be provided to the user.

In certain embodiments, the method further comprises obtaining, with the computer, historical data regarding online chatter associated with the publicly traded financial product from a prior time interval before the first time interval. Determination of the anomaly may be based at least in part on the historical data, and at least in part on comparing, with the computer, a number of posts in the online chatter associated with the publicly traded financial product over the first time interval with a threshold determined using the historical data. The threshold can be determined, at least in part, by feeding, with the computer, the historical data into a first machine learning model trained to determine an average and a standard deviation of a number of posts in the online chatter over the prior time interval in the historical data.

In certain embodiments, determination of the anomaly is based at least in part on the number of posts in the online chatter associated with the publicly traded financial product over the first time interval exceeding a threshold comprising a sum of the average number of posts and a multiple of the standard deviation.

In yet another aspect of the invention, a computer program product comprises a non-transitory computer-readable medium storing instructions thereon that, when executed by one or more processors, causes the one or more processors to: obtain online chatter from one or more social media platforms associated with the publicly traded financial product posted over a first time interval; determine, at the end of the first time interval, an anomaly concerning the publicly traded financial product based at least in part on the online chatter associated with the publicly traded financial product; and responsive to determining the anomaly, cause an alert to be provided to the user.

In certain embodiments, the first time interval is a period of time during a single trading day, and the determination of the anomaly is based at least in part on whether the number of posts in the online chatter associated with the publicly traded financial product over the first time interval exceeds an average number of posts during a same period of time over a number of previous trading days.

In certain embodiments, causing the alert to be provided comprises: obtaining metadata regarding the online chatter in the first time interval; feeding the metadata regarding the online chatter in the first time interval into a machine learning model trained to output a prediction of whether or not a price of the publicly traded security will move more than a predetermined amount based on training data comprising a set of known metadata and known amounts of price movement corresponding to the known metadata; and generating, via the machine learning model, a prediction whether or not a price of the publicly traded financial product will move more than a predetermined amount.

Other features and advantages of the invention will be apparent from the specification and drawings.

### BRIEF DESCRIPTION OF THE DRAWINGS

For a more complete understanding of the invention, reference is made to the following description and accompanying drawings, in which:

FIG. 1 is a block diagram depicting a computing environment for an anomaly detection and alert management system according to an embodiment of the present invention;

FIG. 2 is a block diagram of a database for storing various categories of data used by the anomaly detection and alert management system, in accordance with an embodiment of the present invention;

FIG. 3 is a flowchart of an example methodology for analyzing online chatter associated with a security for an anomaly, and selectively alerting a user as to the presence of the anomaly, in accordance with an embodiment of the present invention;

FIG. 4A is a screenshot of a graphical user interface, showing an alert feed listing a plurality of securities and related information, including market data, online chatter, and a plurality of indicators representative of various aspects of the securities, data analytics, and reporting associated therewith, in accordance with an embodiment of the present invention;

FIG. 4B is a partial screenshot of a graphical user interface, showing the timing of past alerts issued for a security overlayed on a graphical representation of the security's market movements, in accordance with an embodiment of the present invention;

FIG. 4C is a partial screenshot of a graphical user interface, showing an alert feed listing a plurality of securities and a plurality of indictors associated with the securities, including cautionary badges corresponding to different alert types, in accordance with an embodiment of the present invention;

FIG. 4D is a screenshot of an example listing of different types of security badges corresponding to different alert types, in accordance with an embodiment of the present invention;

FIG. 5A is a flowchart of an example methodology for detecting an anomaly for a security based on social media posts, in accordance with the methodology of FIG. 3;

FIG. 5B is a flowchart of an example methodology for determining whether an alert corresponding to the detected anomaly is needed, based on multiple parameters, in accordance with the methodology of FIG. 3; and

FIG. 6 is a schematic diagram depicting an example computing device that may be used in an anomaly detection and alert management system in accordance with various embodiments of the present invention.

### DETAILED DESCRIPTION OF THE PREFERRED EMBODIMENTS

Systems, methods, and computer program products are provided for detecting anomalies in online chatter associated with publicly traded financial products (e.g., publicly traded securities or crypto assets that can be bought, sold, and/or traded on an organized marketplace such as a stock exchange or a crypto exchange, respectively), and alerting users (e.g., investors, broker/dealers, and financial advisors) in real time when an anomaly is detected. In certain embodiments of the invention, systems described herein are also configured to assess when noteworthy market movements (e.g., price movements) of the financial products are likely to occur over short-term time horizons (e.g., within minutes or hours) based on the detected anomalies, and thus, to selectively notify users depending on this additional assessment.

The system of the present invention can be configured to continuously assess online chatter associated with publicly traded financial products and communicate alerts to users in real time when it detects potential imminent and significant volatility (e.g., within minutes or hours), e.g., via a graphical user interface appearing on a user display. In certain embodiments, the graphical user interface shows one or more publicly traded financial products and various types of information associated therewith. For example, in certain embodiments, the system can communicate alerts about expected market movements in predetermined time frames, along with other real-time and/or historic information associated with the financial product, such as previous alerts, the nature of the current alert, an assessment as to whether the movement is based on questionable online activity, whether the financial product has a volatile history, whether the increase in online chatter is small or significant, and whether the financial product has a history of promotional activity associated with patterns of artificial price movement.

As noted above, the challenge of discerning authentic engagement from manufactured online activity is increasing. Additionally, inauthentic activity which gives the appearance of people talking tends to desensitize people over time. Ridicule, conflict, and emotionally driven conversations drive viewership and cause emerging narratives to take hold, even if untrue. Some online chatter spreads disinformation, hype, and/or blatant falsehoods. Capital markets are vulnerable to this issue. Existing systems fail to perceive authentic versus inauthentic activity, such as the appearance of five thousand people talking about a stock when the activity is really fake and done by bots that run automated tasks and perform simple, repetitive, or structured actions faster than humans. The online chatter about a publicly traded financial product can come from a variety of sources, such as Twitter®, Reddit®, Twitch®, Telegram®, one or more blogs, and other open-source or privately acquired data.

As discussed in more detail below, certain embodiments of the invention address a need in the art for improved systems and methodologies that can help investors avoid being manipulated or tricked into buying or selling a security due to inappropriate, fraudulent, false content or otherwise unsavory online activity. The present invention determines new and useful analytics associated with emerging narratives, coded language, and unusual changes (e.g., spikes) in social media, as well as the likelihood that such changes will result in noteworthy price movements. The invention introduces a whole new category of analysis-social media influence on capital markets. This new category of information may now be more impactful than traditional technical analysis (TA) or fundamental analysis, at least with respect to short term price movements of publicly traded financial products.

Given the ever increasing speed with which the internet, social media, and AI generated content are rapidly evolving and allow for information disbursement and connectivity between people, traditional means of communicating information, as well as the types of information typically communicated, are no longer sufficient. Investors need insight into social media influence on price movements as it's happening, how accurate or reliable this influence may be, and whether or not it is likely to last, peter out, or worse, quickly reverse direction. Such information will better help users make more informed decisions with trades.

In certain embodiments, the present invention provides valuable, consolidated, real-time and historic social media information by analyzing social media posts and trends, whether justified or not, that are likely to influence short term price movements of stocks, crypto assets, financial instruments, and any other publicly traded financial asset of value. Alerts are presented to users in real time with indicators and different classifications of caution badges that appear next to the publicly traded security on a display. These alerts and caution badges can be disseminated to traders to give them information they wouldn't otherwise have available to them. Additionally or alternatively, notified brokers and dealers who receive the alerts can pass them on to their customers.

References throughout this specification to features, advantages, or similar language herein do not imply that all of the features and advantages that may be realized with the embodiments disclosed herein should be, or are in, any single embodiment of the invention. Rather, language referring to the features and advantages is understood to mean that a specific feature, advantage, or characteristic described in connection with an embodiment is included in at least one embodiment of the present invention. Thus, discussion of the features, advantages, and similar language throughout this specification may, but not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. These features and advantages will become more fully apparent from the following description, discussion of the drawings, and appended claims, or may be learned by the practice of embodiments of the invention as set forth hereinafter.

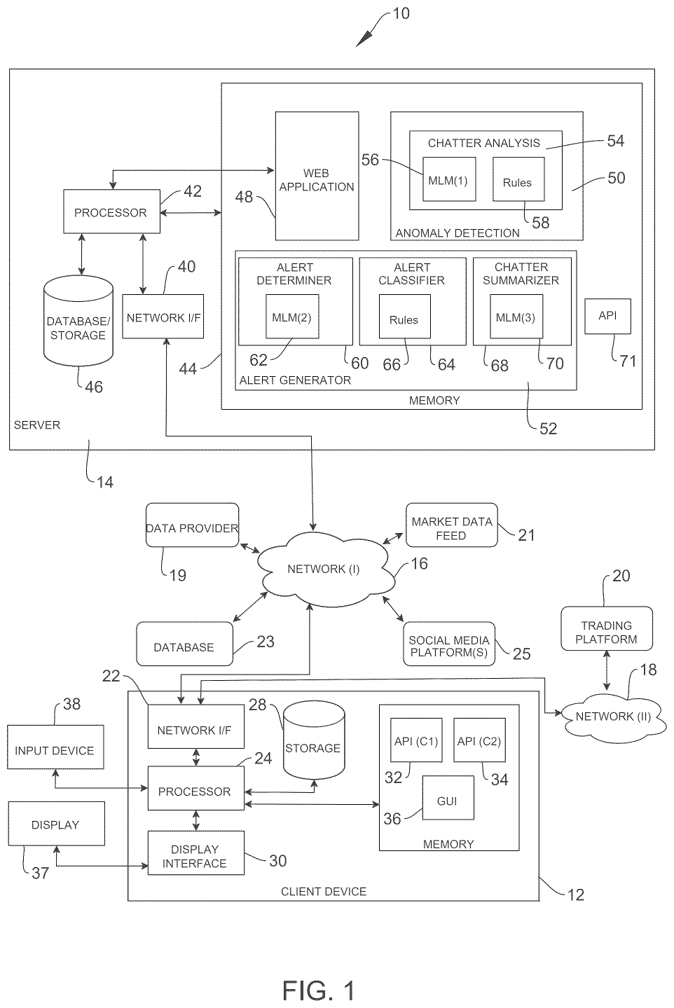

The present invention may be a system, a method, and/or a computer program product at any possible technical detail level of integration. The computer program product may include a computer readable storage medium (or media) having computer readable program instructions thereon for causing a processor to carry out aspects of the present invention. Example embodiments of the present invention relate to an anomaly detection and alert management system. Such embodiments are described in detail below with reference to FIGS. 1-6. While the embodiments described in detail below are directed to publicly traded securities, it will be appreciated that the disclosed system and methodologies may be applied to any type of publicly traded financial products.

Referring to FIG. 1, an example computing environment 10 for an anomaly detection and alert management system according to an embodiment of the invention is shown. As depicted, computing environment 10 includes a client device 12 and a server 14 connected via a network 16. In certain embodiments, client device 12 may also be connected to an electronic trading platform 20 via a secondary network 18. Client device 12 and/or server 14 may also be connected to one or more data providers 19, market data feeds 21, databases 23, and social media platforms 25 via network 16. It is to be understood that the functional division among components of computing environment 10 have been chosen for purposes of explaining present invention embodiments, and is not to be construed as a limiting example.

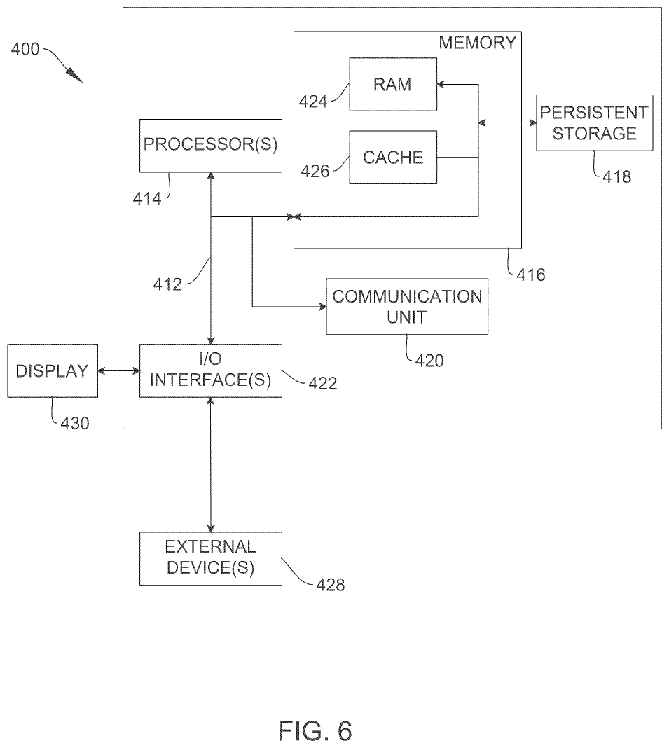

Client device 12 includes a network interface (I/F) 22, at least one processor 24, memory 26, storage 28, and a display interface 30. Memory 26 contains first and second Application Programming Interface (API) modules 32, 34 and a graphical user interface (GUI) module 36. Client device 12 may include a laptop computer, a tablet computer, a netbook computer, a personal computer (PC), a desktop computer, a personal digital assistant (PDA), a smart phone, a thin client, or any programmable electronic device capable of executing computer readable program instructions. Network interface 22 enables components of client device 12 to send and receive data over a network, such as network 16 and network 18. In general, client device 12 receives market data from market data feed 21, and alerts from server 14, and displays the information, via display interface 30, in one or more graphical user interfaces on a display 37. Client device 12 also receives one or more inputs from a user via input device 38, which may be a keyboard, mouse, touchscreen, and/or voice command device which is part of or in communication with client device 12. Client device 12 may include internal and external hardware components, as further depicted and described in further detail below with respect to FIG. 6.

First API module 32, second API modules 34, and a graphical user interface (GUI) module 36 may be implemented by any combination of any quantity of software and/or hardware modules or units, and may reside within memory 26 of client device 12 for execution by one or more processors, such as one or more processors 24. First and second API modules 32, 34 may interface with one or more third parties to receive various forms of information, in lieu of or supplemental to information received from server 14, such as market data, outputs from a large language model (LLM), etc.

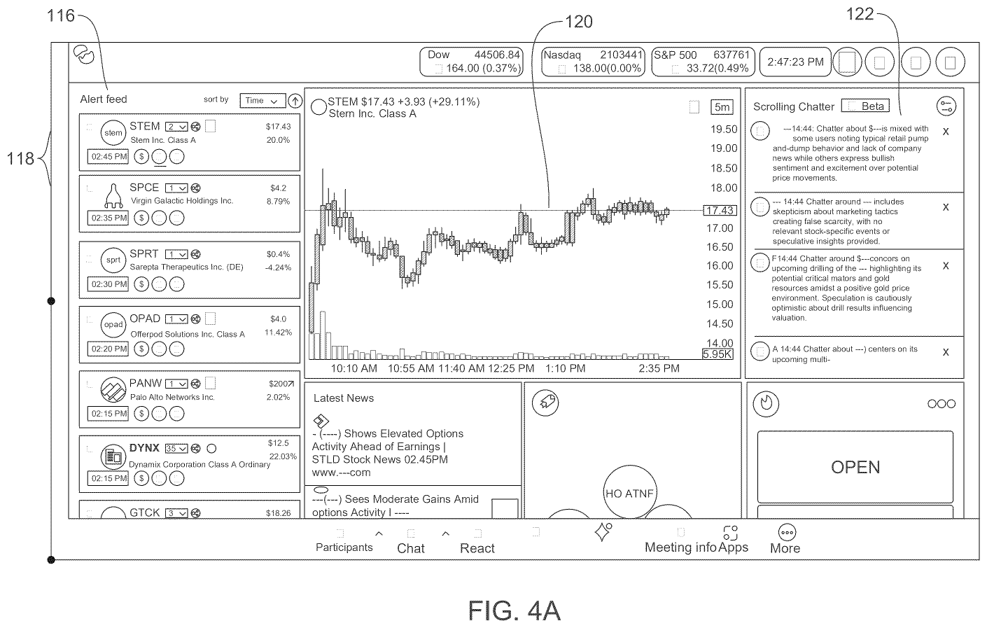

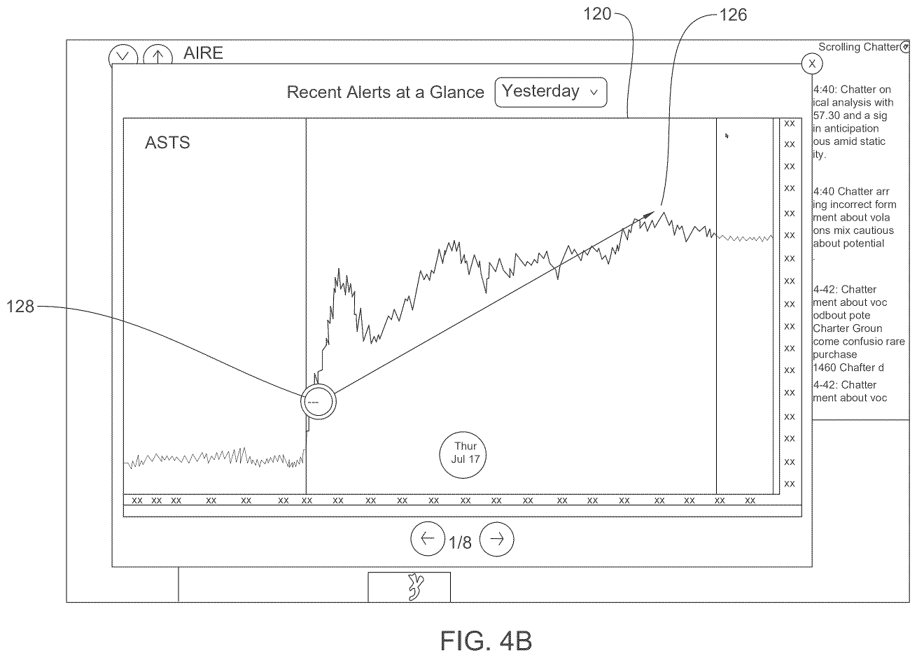

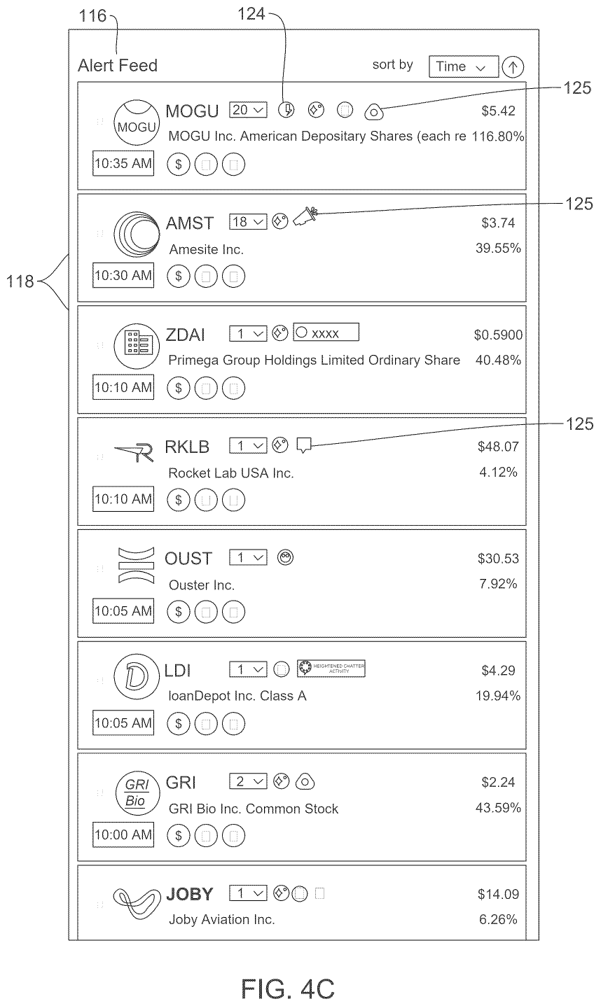

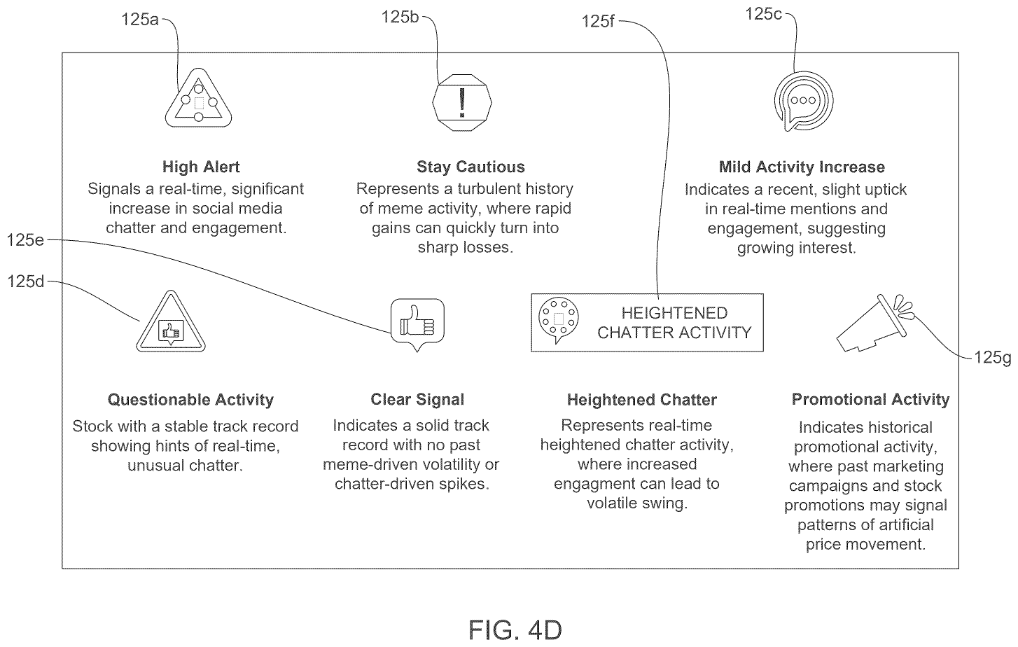

GUI module 36 is configured to provide a graphical user interface on display 37 via display interface 30. GUI module 36 also enables a user to provide one or more inputs via input device 38, and to display information on a display screen (e.g., on display 37). The graphical user interfaces generated by GUI module 36 may also utilize one or more interactive screens, keyboards, and/or buttons, mechanical or electrical, associated with display 37. Examples of a graphical user interfaces generated by GUI module 23 are further described below with respect to FIGS. 4A-4D.

In certain embodiments, GUI module 36 may be in operative communication with first and second API modules 32, 34 and one or more processors 24, and thus communicatively connected to input device 38, display 37, server 14 via network 16 and trading platform 20 via network 18. In certain embodiments, network 18 and network 16 may be the same network. GUI module 36 operates in accordance with various methodology steps for generating new digital content in accordance with the present invention, including graphical user interfaces corresponding to various outputs of the machine learning modules of server 14 (further discussed below).

Storage 28 may include any non-volatile storage media known in the art. For example, storage 28 can be implemented with a tape library, optical library, one or more independent hard disk drives, or multiple hard disk drives in a redundant array of independent disks (RAID). Similarly, data in storage 28 may conform to any suitable storage architecture known in the art, such as a file, a relational database, an object-oriented database, and/or one or more tables.

Server 14 includes a network interface (I/F) 40, at least one processor 42, memory 44, and database/storage 46. Memory 44 contains an anomaly detection module 50, an alert generator module 52, web application 48, and one or more API(s) 71. Anomaly detection module 50 includes a chatter analysis module 54, which includes a first machine learning module MLM(1) 56 and one or more sets of rules 58. Alert generator module 52 includes an alert determiner module 60 including a second machine learning module MLM(2) 62, an alert classifier module 64 containing one or more sets of rules 66, and a chatter summarizer module 68 containing a third machine learning module MLM(3) 70. Modules 48, 50, 52, and 71 comprise instructions executable by processor 42, which is in communication with database 46 and a network interface 40, to process inputs received from client device 12, retrieve or store data in database 46, and generate one or more outputs for client device 12. The outputs may be transmitted, via network interface 40, to client device 12 for presentation to a user in one or more graphical user interfaces. In certain embodiments, web application 48 may publish a web page for client device 12. In other embodiments, client device 12 may include an app for communicating with the various modules on server 14.

Server 14 may include a laptop computer, a tablet computer, a netbook computer, a personal computer (PC), a desktop computer, a personal digital assistant (PDA), a smart phone, a thin client, or any programmable electronic device capable of executing computer readable program instructions. Network interface 40 enables components of server 14 to send and receive data over a network, such as network 16. In general, server 14 and its modules support anomaly detection in online chatter related to publicly traded securities, and selective alert generation via the various method steps described herein. Server 14 may include internal and external hardware components, as depicted and described below with respect to FIG. 6.

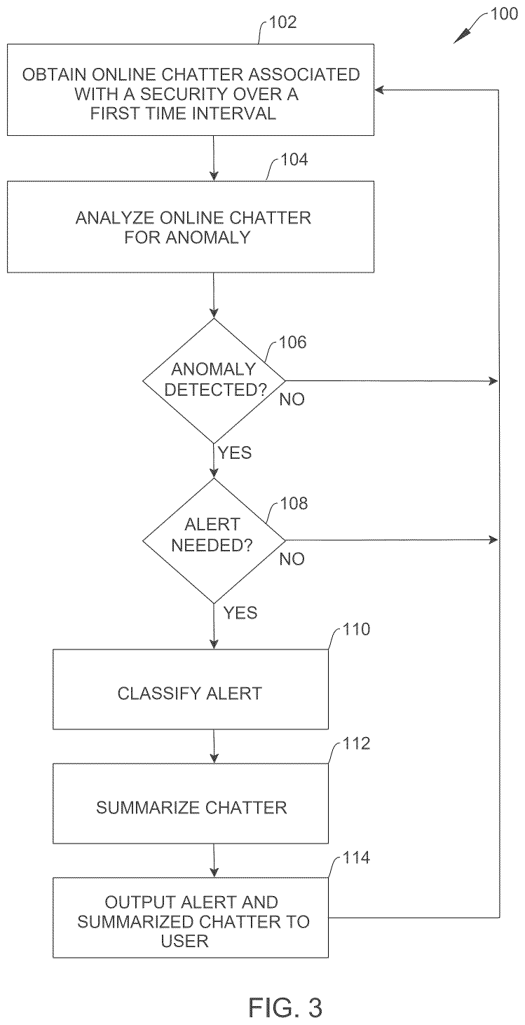

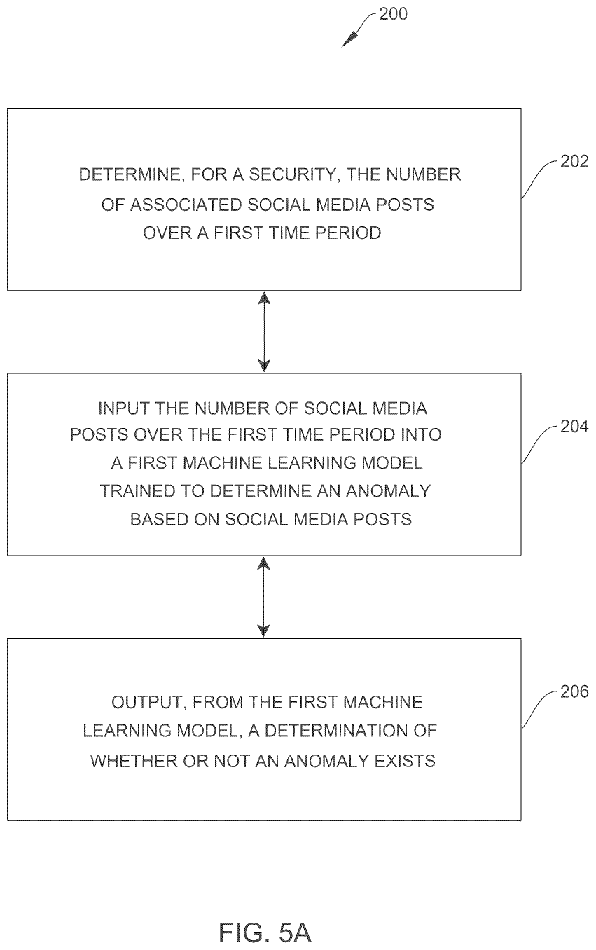

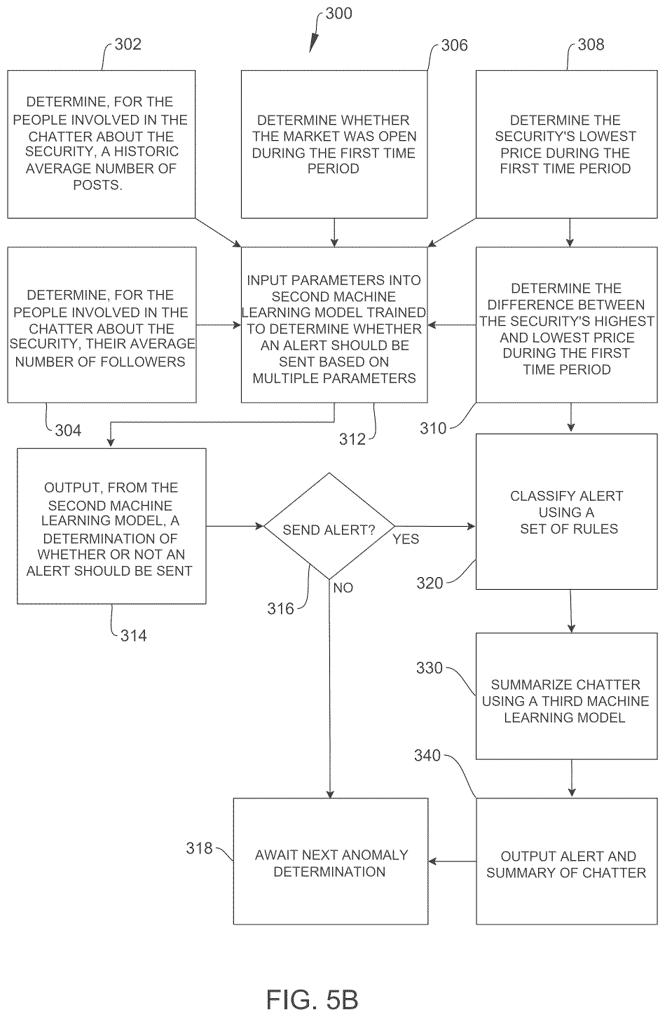

Each of the modules stored in memory 26 of client device 12 and memory 44 of server 14 may include one or more sub modules or units to perform various example functions and methodologies of the present invention. As an example, chatter analysis module 54, alert determiner module 60, alert classifier module 64, and chatter summarizer module 68 may be implemented by any combination of any quantity of software and/or hardware modules or units, and may reside within memory 44 of server 14 for execution by one or more processors, such as processor 42. Chatter analysis module 54, alert determiner module 60, alert classifier module 64, and chatter summarizer 68 in memory 44 of server 14 are further discussed below with respect to FIGS. 3, 5A, and 5B. Rules 58, 66 may each include one or more sets of computer readable rules that are persisted (e.g., stored or maintained) in memory 44 of server 14, accessible by server, and optionally, by client device 12, and used by the appropriate processor for chatter analysis and alert classification, respectively.

Database/storage 46 may include any non-volatile storage media known in the art. For example, database 46 can be implemented with a tape library, optical library, one or more independent hard disk drives, or multiple hard disk drives in a redundant array of independent disks (RAID). Similarly, data in database 46 may conform to any suitable storage architecture known in the art, such as a file, a relational database, an object-oriented database, and/or one or more tables.

Network 16 and network 18 may include a local area network (LAN), a wide area network (WAN) such as the Internet, or a combination of the foregoing, and includes wired, wireless, or fiber optic connections. In general, networks 16, 18 can be any combination of connections and protocols known in the art that will support communications between client device 12 and/or server 14 via their respective network interfaces 22, 40 in accordance with embodiments of the present invention.

The above described system and/or components thereof may be used to implement various methodologies of the present invention, described below with respect to FIGS. 3-5B, which give rise to the advantages described above, and many others described herein.

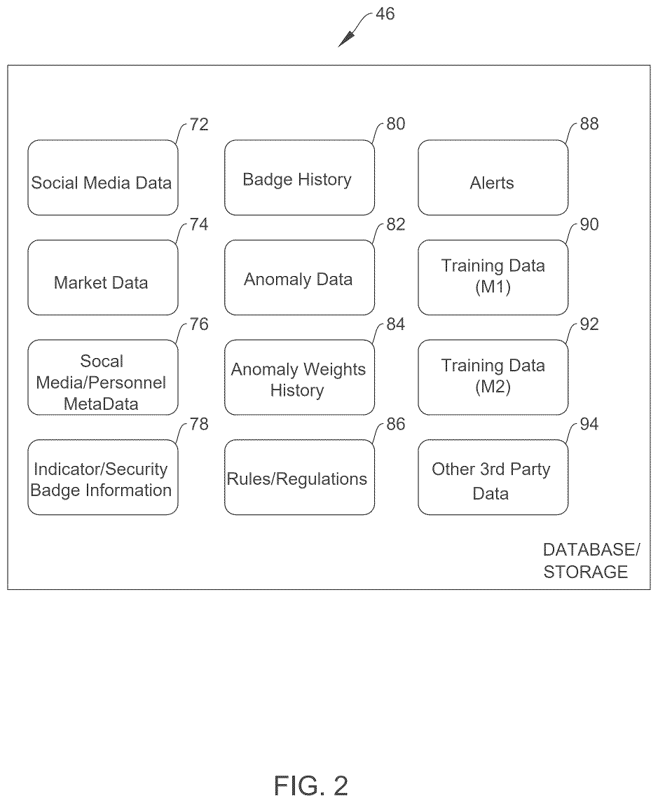

Referring to FIG. 2, database/storage 46 of server 14 may store various categories of data used by anomaly detection and alert management system in accordance with the present invention. For example, database 46 may include data such as social media data 72, market data 74, social media/personnel metadata 76, indicator/security badge information 78, badge history 80, anomaly data 82, anomaly weights history 84, one or more sets of rules/regulations 86, alert(s)/alert history 88, first training data (M1) 90 for training chatter analysis module 54 of anomaly detection module 50, second training data (M2) 92 for training second machine learning model MLM(2) 62 of determiner module 60 of alert generator module 52, and other third party data 94. This data may additionally or alternatively be stored in one or more databases 23 in communication with server 14 via network (I) 16. In certain embodiments, at least a portion of this data may also be stored in storage 28 of client device 12.

Social media data 72 may include real-time social media data (e.g., data about social media events and posts which have occurred in the past minute, hour, day, or other short term time period) and historic social media data (data about social media events and posts which occurred in any time period longer than the short time period, or in any time period which preceded the present or first time period). This data may include, for example, every social media post collected, time stamps (e.g., date and time of each post), authorship information associated with each post, the platform on which each post occurred, an ID assigned for each post to facilitate easier lookup or searching, and a level of engagement which transpired after each post (e.g., the number of new or related posts since the last update in the data, the number of followers, etc.).

Market data 74 may include the name of each publicly traded financial product, such as, for example, the stock or crypto name, assigned ID number, price, trading volume over time, time stamps corresponding to trades or trade prices, market capitalization, and a description of the company. Market data 74 may be organized, for example, with one table having the stock description, ticker, name, the number of and names of employees, the company website, and stock metadata. Market data 74 may also include another table containing the opening price of the publicly traded financial product, the high and low prices for a plurality of time intervals (e.g., every five minutes) starting at market open and ending at market close. In other examples, the market intervals may be one minute, two minutes, three minutes, four minutes, ten minutes, twenty minutes, half an hour, forty-five minutes, or one hour. Other time intervals may be used and stored (further discussed below). This data may be stored in a file, or in tables within database 46.

Social media/personnel metadata 76 may include, for example, the number of followers each social media poster has, how many people each follower follows, all metadata associated with each follower's activity, their user name, and their account. Indicator/security badge information 78 may include indicator types to be displayed in various graphical user interfaces on display 37 of client device 12 along with other security information, a table of badges containing definitions, and the type of alert to which each security badge corresponds. Badge history 80 can include current and past badges utilized, the number of times each type of badge was issued for a given publicly traded financial product, and the date and time the badge was utilized.

Anomaly data 82 may include, for each publicly traded financial product, data that is calculated and used to determine whether or not an anomaly is present. Such data may include, for example, an exponential smoothing average and an exponential smoothing standard deviation for the prior twenty-one (21) trading days. Anomaly weights history 84 may include a recording of the particular weightings used over time by the machine learning model described herein for anomaly detection module 50 (further discussed below).

Rules/regulations data 86 may include any information associated with any rule for any algorithm utilized, seasonality checks, checks for badging, and a history of all queries run on database 46. Alerts 88 may include a table of alerts, a summary associated with each alert, the date and time each alert was issued, and a summary of the chatter presented with the alert for display to the user. Alerts 88 and/or market data 74 may include information associated with same day price movements of publicly traded financial products before and after each alert.

Training data (M1) 90 is used to train machine learning model (MLM) 56, and can be continually updated over time. Training data (M2) 92 is used to train machine learning model (MLM) 62, and can also be continually updated over time. For example, training data (M1) 90 and training data (M2) 92 may include portions of historical data in social media data 72 and portions of historical data in market data 74. Training data for the machine learning models described herein may come from these and other sources. For example, other data 94 may be stored in database/storage 46 from third party suppliers. In certain embodiments, training data (M1) 90 and training data (M2) 92 may simply be categorized and stored as anomaly data 82 along with the other forms of anomaly data 82 noted above.

The data used to populate database 46 of server 14 may be obtained from the outputs of chatter analysis module 54, alert determiner module 60, alert classifier module 64, chatter summarizer module 68, client device 12, and one or more of data provider 19, database 23, market data feed 21, and one or more social media platform(s) 25 connected to network (I) 16. Data base 46 may also be populated by obtaining data from other sources and through other means (such as, e.g., web crawlers and data scrapers).

Referring to FIG. 3, shown is an example methodology/process 100 for analyzing online chatter associated with a security for an anomaly, and selectively alerting a user as to the presence of the anomaly, in accordance with an embodiment of the present invention. Each element in flowcharts shown or methodologies described herein, such as process 100 of FIG. 3, process 200 of FIG. 5A, and process 300 of FIG. 5B depicts a step or a group of steps of novel computer-implemented systems and methodologies for detecting anomalies in online chatter associated with publicly traded financial products, and selectively alerting users when an anomaly likely to result in significant volatility is detected. Each step of the methodologies described herein may contain one or more sub-steps. For purposes of illustration and explanation, these steps, as well as all other steps identified and described, are presented in a certain logical order. However, it will be appreciated that any exemplary embodiments described herein can contain an alternate order of the steps adapted to a particular application of a technique disclosed, and that any such variations and/or modifications are intended to fall within the scope of the invention. The depiction and description of steps in any particular order is not intended to exclude embodiments having the steps in a different order, unless required by a particular application, explicitly stated, or otherwise clear from the context.

Continuing with FIG. 3, at Step 102, server 14 obtains, via processor 42, online chatter associated with a security over a first time interval (e.g., the prior five minutes). In certain embodiments, processor 42 may obtain the online chatter from one or more data providers or data feeds 19, and/or social media platforms 25 over network 16, such as via one or more APIs. Alternatively, server 14 of anomaly detection and alert management system 10 may acquire this data directly to the extent possible from publicly available data.

For example, server 14 may be configured to retrieve at least a portion of the online chatter data using via web crawlers, scraping, or by querying publicly available application interfaces for online social media platforms (e.g., as Twitter®, Reddit®, Twitch®, Telegram®, Facebook®, Yahoo®, and open-source data). Processor 42 executes instructions stored in memory 52 to parse and store the obtained online chatter data in database 46. The data may be stored in accordance with, for example, one or more of the categories described above with respect to FIG. 2.

A certain amount of acquisition time (e.g., sixty seconds) is required to acquire data from the most recent time interval (e.g., the prior five minutes of data). After the most recent time interval data is acquired (e.g., after sixty seconds), system 10 may be configured to pause for the remainder of the current time interval (e.g., for four minutes). At the expiration of the current time interval (e.g., after four minutes), data acquisition may repeat for the prior time interval (e.g., to acquire the past five minutes of data), and the data may be stored in database 46. In this manner, system 10 may obtain online chatter continuously for a plurality of time intervals (e.g., a plurality of five minute time intervals) throughout the day, including, and possibly before and after, market open and market close. Other predetermined time intervals may be utilized, such as half a minute, one minute, three minutes, ten minutes, fifteen minutes, half an hour, an hour, and several hours. Historical data (e.g., social media data such as postings that occurred before the first or present time interval) provides a basis for comparison with present real-time data, and thus may be used to determine anomalies as described herein.

Online chatter refers to any comment or message posted on an online social media platform, blog, forum, or the like. Such posted comments and messages may also be referred to as “posts” herein. Online chatter may be considered associated with a publicly traded financial product if, for example, it explicitly mentions the financial product. For example, in the case of a publicly traded security, online chatter may be considered associated with the security if it uses the security's name, ticker, company name, company DBA name, company abbreviation, or nickname, in its text. Replies to a post mentioning the financial product may also be considered online chatter associated with the financial product. In certain embodiments, the post, its text, title, description, author, date, and time of posting are all recorded. In certain embodiments, the anomaly detection and alert system (e.g., server 14) may be configured to track and store online chatter for thousands of publicly traded financial products (e.g., up to seven thousand publicly traded financial products), in accordance with process 100 for each publicly traded financial product.

At Step 104, the server 14 analyzes the online chatter obtained during the first time interval (e.g., the past five minutes) for an anomaly. Processor 42 executes chatter analysis module 54, which contains machine learning model MLM(1) 56 and one or more sets of rules 58 for analyzing the online chatter obtained during the first time interval based on historic online chatter obtained for the same security during a second predetermined time interval preceding the first time interval (further discussed below with respect to FIG. 5A). Thus, processor 42 may be instructed to query database 46 at the expiration of each predetermined time interval (e.g., five minutes). Other time intervals may be utilized.

At Step 106, server 14, via processor 42, outputs a decision from anomaly detection module 50 as to whether or not an anomaly exists for the security. If no anomaly is detected, then system 10 returns to Step 102 and continues obtaining online chatter associated with the security over the first time interval (e.g., over a new five minute period).

At Step 108, if an anomaly is determined, then server 14 determines whether an alert is needed. Processor 42 executes alert generator module 52, which contains alert determinator 62 for determining whether an alert is needed. The existence of an anomaly in current online chatter for a security does not in and of itself portend a significant and imminent market movement of the security. The analysis to determine whether an alert is needed involves a number of factors, and is further discussed below with respect to FIG. 5B. If system 10 determines that no alert is needed, then system 10 returns to Step 102 and continues obtaining online chatter associated with the security over a new time interval, which may be the next five minute interval as discussed above.

At Step 110, if server 14 determines that an alert is needed, then processor 42 executes alert classifier 64, which classifies the alert based on one or more sets of rules 66. At Step 112, processor 42 executes chatter summarizer 68, which contains a third machine learning module MLM(3) 70, which may include a large language model, to create a summary of the online chatter to accompany the alert. At Step 114, processor 42 outputs the classified alert to the user via network interface 40, which is connected to client device 12 via network (I) 16. The alert may include a particular type of security badge and one or more additional indicators pertaining to the security.

FIGS. 4A-4C show example graphical user interfaces containing an alert feed 116 listing a plurality of securities 118 and related information, including market data (e.g., a graph 120 of a selected security's price over time), online chatter 122, and a plurality of indicators 124 representative of various aspects of the securities, data analytics, and reporting associated therewith, in accordance with the present invention. FIGS. 4A-4C are for illustrative purposes only, and are not meant to reflect actual data regarding the securities listed. FIG. 4B illustrates an example graphical user interface 126 in which the timing of a past alert 128 for a security is highlighted, and overlayed on graphical representation 120 of the security's market movements, in accordance with the present invention. As shown in FIG. 4C, one of indicators 124 may be a security badge 125 having a distinct symbol shape corresponding to a particular type of alert. Security badge 125 allows a user to quickly ascertain the nature of an alert and whether caution is advised without having to read any text or process other information. As best shown in FIG. 4D, different types or classifications of security badges 125a-125f may be displayed next to the security ticker depending on the type of alert.

Security badge 125a may be configured in the shape of a triangle with a particular design inside, signifying ‘High Alert,’ a real-time significant increase in social media chatter and engagement. This security badge 125a may be colored red. Security badge 125b may be configured with a ten sided circular shape (e.g., a decagon) with an exclamation point inside, signifying ‘Stay Cautious,’ a turbulent history of meme activity where rapid gains can quickly turn into sharp losses. Security badge 125c may be configured with two partial circles concentric with one another, three dots across the center, and a beak-like structure extending downward from the inner partial circle, signifying ‘Mild Activity Increase.’ This badge indicates a recent, slight uptick in real-time social media mentions of the security, and engagement suggestive of growing interest.

Security badge 125d is also triangular shaped, but contains a thumbs up logo inside against a white shield. This badge may be colored yellow, and signifies ‘Questionable Activity,’ a stock that has a stable track record, but is showing hints of real-time, unusual chatter. In other words, this badge is indicative of a security that does not have a history of pumping and dumping or high volatility, and is demonstrating incongruent behavior. Security badge 125e is configured as a shield with a thumb's up indicia, and no triangle. This badge signifies ‘Clear Signal,’ a security with a solid track record with no past meme-driven volatility or chatter-driven spikes. Security badge 125f is configured as a banner indicating ‘heightened chatter activity,’ and thus is a warning about real-time heightened chatter associated with the security, a situation where increased engagement can lead to volatile swings. Finally, security badge 125g is configured as with a horn or speaker shape, and signifies ‘Promotional Activity.’ This security badge indicates that the stock has historically had promotional activity in which past marketing campaigns and stock promotions have signaled patterns of artificial price movement. It will be appreciated that these caution badges of varying classifications give investors meaningful warnings about impending price movements and the potential reasons for the likely moves. It will be appreciated that other caution badge designs and alert classifications may be used.

Referring to FIG. 5A, a process 200 for detecting an anomaly for a particular security based on social media posts is shown, in accordance with Step 104 of FIG. 3. At Step 202, server 14 determines, for the particular security, the number of associated social media posts that have been made about the security over a first predetermined time period (e.g., five minutes). Processor 42 executes chatter analysis module 54 of anomaly detection module 50, and queries database 46 to retrieve social media data 72 associated with the particular security over the latest predetermined time period, and determines a total number of social media posts that referred to the particular security.

In certain embodiments, server 14 may be configured to remove posts which appear to be spam (e.g., posts that reference fifty different securities, and thus have very little influence because most people ignore them) from analysis. When querying database 46, processor 42 applies rules 58 in chatter analysis module of anomaly detection module 50. For example, rules 58 may include a rule instructing that if a post mentions more than ten different securities, it is to be ignored and/or removed from database 46. In this manner, spam posts are not counted in the tally. In other embodiments, rules 58 may include a rule 58 instructing to divide the number of followers of a person who posted a particular post by the number of stock tickers referenced in the post. If this ratio is above a certain threshold, then the post is retrieved and counted. If the ratio is below the predetermined threshold, then the post may be discounted.

In yet other embodiments, rules 58 may contain a rule instructing that if the author of a particular post has historically not had any influence on the movement of a stock, then the post may be ignored or discarded. Rules 58 may also contain a rule instructing processor 42 to determine the age of a poster's account. If a poster's account is, for example, over 18 months old, then that person will tend to have more influence in moving a stock. If an account is eight days old, a rule may instruct processor 42 to discard the post. In short, at the time of querying database 46, rules 58 are applied by processor 42 to each post, and system 10 decides, based on the query and rules 58, whether to keep each post for anomaly analysis, or whether to discard it.

The removal or discarding of social media posts/online chatter by system 10 through implementing rules 58 allows for not only a more accurate detection of an anomaly, but also a technological improvement in system processing. System 10 is able to work more efficiently, do calculations faster, and/or reduce the amount of data stored. System 10 may be configured to store the moving average and standard deviation of the number of daily posts corresponding to each security, and to update these numbers at the end of each day.

At Step 204, processor 42 inputs or feeds the total number of social media posts determined for the security at Step 202 for the first time period into first machine learning model MLM(1) 56, which is trained to determine an anomaly based on the observed (real-time) and historic social media posts. In certain embodiments, machine learning model MLM(1) 56 may be configured to take inputted social media posts and determine whether the number of posts during the first predetermined time period (which survive the database query and rules 58) is greater than a predetermined threshold, such as, for example, two standard deviations more than the exponential moving average of the number of posts made per day on the security in the previous twenty-one trading days. The threshold may be determined, at least in part, by feeding historical data into first machine learning model MLM(1) 56, which is trained to determine an average and a standard deviation of a number of posts in the online chatter over the prior time interval in the historical data. In certain embodiments, such thresholds may also be determined, for example, using a predetermined percentage by which the number of posts in the online chatter associated with the publicly traded security over the first time interval exceeds historic averages.

In certain embodiments, MLM(1) 56 is an unsupervised machine learning model that considers an anomaly to be a significant spike in chatter, with certain exceptions/checks. MLM(1) 56 may be trained, for example, with a number of historic posts considered to be an anomaly. MLM(1) 56 can review, for example, three weeks of data at the daily level, and determine an average number of posts, as well as the standard deviation in the number of posts, for each publicly traded security. Thus, in certain embodiments, MLM(1) 56 reviews, for each publicly traded security, twenty-one daily inputs. Each input is a number of posts per day per stock. In certain embodiments, this twenty-one day look back at historic data may be twenty one trading days (e.g., when the market is actually open), and thus, represents a little over a month of trading on average.

Server 14 may be configured to update the average number of posts and the standard deviation each day for each publicly traded security, based on new data. In certain embodiments, processor 42 multiplies the standard deviation by two, adds that amount to the average number of daily posts for the security, and compares this result to the total number of posts made about the publicly traded security over the predetermined time period (e.g., five minutes).

At Step 206, anomaly detection module 50 outputs, from machine learning module MLM(1) 56, a determination of whether or not an anomaly has been detected. For example, if the total number of posts about the security during the predetermined time period is greater than twice the average standard deviation of the daily number of posts plus the daily average during the lookback period (e.g., twenty-one trading days), then anomaly detection module 50 determines that an anomaly is present. If the total number of posts during the predetermined time period is less than this amount, then no anomaly is detected.

In certain embodiments, MLM(1) 56 may be configured to use an exponential smoothing average to determine the average daily number of posts for each security, and to weigh more recent daily totals more than the older daily totals. In other words, MLM(1) 56 may be configured to assign higher weightings to the number of daily posts received more recently than the number of daily posts received about the security thirteen days ago. In certain embodiments, the weightings assigned to each day may decrease for each day up to a twenty-one trading day lookback. The assigned weights may be stored in database 46. Averaging methods like exponential smoothing or linear or weighted averaging may be utilized, and compared against a baseline such as 7 days, 14 days, 21 days, 30 days or any other number deemed fit based on historical trends.

MLM(1) 56 may also be configured to implement a seasonality detection test over a shorter lookback period, such as, for example, fourteen days. If, on a certain day at a certain time, conversations about securities usually increase, then a spike in the number of posts during that time period may not be indicative of an anomaly. Server 14 may thus be configured to implement a seasonality test even if the number of posts during the predetermined time period is two standard deviations above the smoothed daily average, and to discard the spike in posts if the seasonality test indicates that a spike in activity during the predetermined time period is normal. This prevents the old data from having too much influence more recent data that may be more informative. Machine learning model MLM(1) 56 may be structured to discover patterns, and the various parameters discussed above may be adjusted until better results are obtained.

In certain embodiments, the anomaly determination occurs at the end of the first time interval (e.g., immediately upon expiration of the first time interval or shortly thereafter, such as within fifteen minutes or less of the expiration of the first time interval). If the market will be closed within half an hour or forty-five minutes of the expiration of the first time interval, the system may be configured to immediately perform the anomaly determination upon expiration of the first time interval. It will be appreciated that time is of the essence since alerts to users preferably occur shortly before (e.g., within forty five minutes) of anticipated movement of the publicly traded security.

Referring to FIG. 5B, a process 300 is shown for determining whether an alert corresponding to a detected anomaly is needed, based on multiple parameters, in accordance with step 108 of the methodology of FIG. 3. In particular, processor 42 executes alert determinator module 60, which includes neural network/machine learning module MLM(2) 62, to analyze five inputs parameters.

At Step 302, processor 42 determines, for the people (posters) involved in the chatter about the security, a historic average number of posts in the past seven days at the daily level. These values are then averaged to get an average number of posts per day per person over seven days. At Step 304, processor 42 determines, for the people involved in the chatter about the security, their average number of followers. Thus, the system 14, via processor 42, can determine the average total followers and the average total posts in the past seven days. At Step 306, processor determines whether or not the market was open during the first time period. At Step 308, processor 42 determines, from market data 74 in database the security's lowest price during the first predetermined time period.

At Step 310, processor 42 determines a difference between the securities highest and lowest price during the first predetermined time period.

At Step 312, these five parameters (average total posts, average number of followers, whether or not the market was open during the predetermined time period, the security's lowest price during the time period, and the difference between the security's highest and lowest price during the predetermined time period) are inputted into second machine learning model MLM(2) 62, which is trained to determine whether an alert should be sent based on these five parameters. The machine learning model may be implemented by any suitable machine learning techniques (e.g., mathematical/statistical, classifiers, feed-forward, recurrent, convolutional, or other neural networks, etc.). For example, a neural network may be used that includes an input layer, one or more intermediate layers (e.g., including any hidden layers), and an output layer. Each layer may include one or more nodes or neurons, where the input layer neurons receive input (e.g., image data, feature vectors of images, etc.), and may be associated with weight values. The neurons of the intermediate and output layers may be connected to one or more neurons of a preceding layer, and receive as input the output of a connected neuron of the preceding layer. Each connection may be associated with a weight value, and each neuron may produce an output based on a weighted combination of the inputs to that neuron. The output of a neuron may further be based on a bias value for certain types of neural networks (e.g., recurrent types of neural networks). The weight (and bias) values may be adjusted based on various training techniques. For example, the machine learning of the neural network may be performed using a training set including various combinations of values for the five parameters discussed above as input and corresponding outcomes (e.g., significant price movement or no significant price movement) as known outputs, where the neural network attempts to produce the provided output and uses an error from the output (e.g., difference between produced and known outputs) to adjust weight (and bias) values (e.g., via backpropagation or other training techniques).

In certain embodiments, MLM(2) 62 is trained using data sets of known parameters (e.g., various combinations and values of the five parameters discussed above) and known outcomes associated with the known parameters (e.g., whether or not the security moved significantly in the next forty five minutes). In certain embodiments, a significant move may be defined by a formula taking into account a price of the security and a percentage of the move. For example, for stocks above $4 per share, a significant move could be at least 2%. A matrix may be utilized and applied to determine what would constitute a significant market move, what the average trader would want to see in order to be able to profit from the move.

At Step 314, processor 42 outputs, from neural network/machine learning module MLM(2) 62 a determination of whether or not an alert should be issued. At Step 316, system 14 decides whether an alert determines no alert is needed, then processor 42 awaits the next anomaly determination. At Step 308, if no alert is to be sent, then processor 42 awaits the next anomaly determination. At Step 320, if an alert is to be sent, then processor classifies the alert in accordance with one of the classifications discussed above with respect to FIG. 4D, using machine learning rules. If a stock has a turbulent history with memes activity, and rapid gains turning into sharp losses, then system 14 may be configured to log any turbulence which occurs.

At Step 330, processor 42, using chatter summarizer 68, which contains a third machine learning model MLM(3) 70, summarizes the online chatter for the security, and explains what all the chatter is about. MLM(3) 70 may include a large language model (LLM), and be part of alert generator 52 as shown, or hosted on a remote device or server whereby the chatter summary may be obtained by server 14. At Step 340, processor 42 outputs the alert and a summary of the chatter 340 to client device 12 via network interface 40 and network (I) 16.

Referring to FIG. 6, the systems and methodologies described herein may be implemented using a wide variety of computing components and devices. An example computing device 400 is shown that may be used for one or more computing devices of anomaly detection and alert management system (e.g., server 14 and/or client device 12) for executing the various methodologies disclosed herein. One or a plurality of such computers 400 may implement server 14 and/or client device 12. Computing device 400 may comprise or be in remote communication with one or more external devices 428 and one or more processors, in addition to one or more processors 414 implemented therewith. It will be appreciated that FIG. 6 provides only an illustration of one embodiment, and does not imply any limitations with regard to the environments in which different embodiments may be implemented. Many modifications to the depicted environment may be made.

As depicted, the computer 400 includes communications fabric 412, which provides communications between computer processor(s) 414, memory 416, persistent storage 418, communications unit 420, and input/output (I/O) interface(s) 422. Communications fabric 412 can be implemented with any architecture designed for passing data and/or control information between processors (such as microprocessors, communications and network processors, etc.), system memory, peripheral devices, and any other hardware components within a system. For example, communications fabric 412 can be implemented with one or more buses.

Memory 416 and persistent storage 418 are computer readable storage media. In the depicted embodiment, memory 416 includes random access memory (RAM) 424 and cache memory 426. In general, memory 416 can include any suitable volatile or non-volatile computer readable storage media.

One or more programs may be stored in persistent storage 418 for execution by one or more of the respective computer processors 414 via one or more memories of memory 416. The persistent storage 418 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information. The media used by persistent storage 418 may also be removable. For example, a removable hard drive may be used for persistent storage 418. Other examples include optical and magnetic disks, thumb drives, and smart cards that are inserted into a drive for transfer onto another computer readable storage medium that is also part of persistent storage 418.

The computer readable storage medium can be a tangible device that can retain and store instructions for use by an instruction execution device. The computer readable storage medium may be, for example, an electronic storage device, a magnetic storage device, an optical storage device, an electromagnetic storage device, a semiconductor storage device, or any suitable combination of the foregoing. A non-exhaustive list of more specific examples of the computer readable storage medium includes: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In certain embodiments, data stored in database 46 may be received as input data, structured data feeds (e.g., market data from a market data feed), online chatter from social media platforms, etc., and can include any information provided to or generated by client device 12 and/or server 14. Data may also be in any desired format, size, field type, and arrangement, and may include data collected about stored content by a collection mechanism, a combination of collected information, and any information derived from analyzing the collected information. The data may be stored using conventional or other data structures (e.g., files, arrays, lists, stacks, queues, records, etc.) in one or more of the desired storage units (e.g., databases, data or other repositories, queues, etc.). Data transmitted between a client device (e.g., one of computing devices 428 arranged remotely) and/or a server (e.g., server 14 included in computing system 10) may comprise any desired format and arrangement, including various types of fields of varying size to store the data. In certain embodiments, the definition and data model for datasets may indicate the overall structure in any desired fashion (e.g., computer-related languages, graphical representation, listing, etc.).

Communications unit 420, in these examples, provides for communications with other data processing systems or devices. In these examples, communications unit 420 includes one or more network interface cards. Communications unit 420 may provide communications through the use of either or both physical and wireless communications links.

I/O interface(s) 422 allow for input and output of data with other devices that may be connected to computer 410. For example, I/O interface 422 may provide a connection to external devices 428 such as a keyboard, keypad, a touch screen, and/or some other suitable input device. External devices 428 can also include portable computer readable storage media such as, for example, thumb drives, portable optical or magnetic disks, and memory cards.

Software and data used to practice embodiments of the present invention can be stored on such portable computer readable storage media and can be loaded onto persistent storage 418 via I/O interface(s) 422. I/O interface(s) 422 may also connect to a display 430. Display 430 provides a mechanism (e.g., a computer monitor) to display data to a user.

### Programs/Software

It will be understood by those skilled in the art that software of the present invention embodiments may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry. The software of the present invention embodiments may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The computer readable program instructions can be downloaded to respective computing/processing devices from a computer readable storage medium or to an external computer or external storage device via a network, for example, the Internet, a local area network, a wide area network and/or a wireless network. The network may comprise electrically-conductive transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language, a multi-paradigm programming language like Python, or other suitable programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

References herein to software performing various functions generally refer to computer systems or processors performing those functions under software control. The computer systems of embodiments of the present invention may alternatively be implemented by any type of hardware and/or other processing circuitry. The various functions of the computer or other processing systems may be distributed in any manner among any number of software and/or hardware modules or units, processing or computer systems and/or circuitry, and the computer or processing systems may be disposed locally or remotely of each other and communicate via any suitable communications medium (e.g., LAN, WAN, Intranet, Internet, hardwire, modem connection, wireless, etc.).

For example, the functions of embodiments of the present invention may be distributed among various end-user/client and server systems, and/or any other intermediary processing devices. The software and/or algorithms described herein and illustrated in the figures may be modified in any manner that accomplishes the functions described herein.

The software of embodiments of the present invention may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer readable program instructions may be provided to a processor of a computer, or other programmable data processing apparatus such that the instructions, which execute via the processor of the computer or other programmable data processing apparatus, create means for implementing the functions/acts specified in the flowchart and/or block diagram block or blocks. The computer readable program instructions can be stored in a computer readable storage medium that can direct a computer, a programmable data processing apparatus, and/or other devices to function in a particular manner. Alternatively, the computer readable program instructions can be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

### Electronic Circuitry

In certain embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. It will be understood that each block of the flowchart illustrations and/or block diagrams, and combinations of blocks in the flowchart illustrations and/or block diagrams, can be implemented by computer readable program instructions.

### Computing Environment

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software. These systems may include any types of monitors and input devices (e.g., keyboard, mouse, voice recognition, etc.) to enter and/or view information.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

It will be appreciated that the environment of embodiments of the present invention may include any number of computers or other processing systems (e.g., client or end-user systems, server systems, etc.) and databases or other repositories in different arrangements and applied to different types of computing environments (e.g., cloud computing, client-server, network computing, mainframe, stand-alone systems, etc.). The computer(s) or other processing systems employed by embodiments of the present invention may be implemented by one or more personal or other types of computers or processing systems (e.g., desktop, laptop, PDA, mobile devices, etc.), and may include commercially available operating systems and a combination of commercially available and custom software (e.g., communications software, server software, a word processing module, one or more pre-processors, template processors, a feed generator module, a document manager, etc.). These systems may include monitors and input devices (e.g., keyboard, mouse, voice recognition, etc.) to enter and/or view information.

### Communication Network

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The various systems and methodologies described herein may also include one or more servers arranged in a distributed structure with support from data centers located anywhere in the world. Implementations may be communicatively linked, cross-platformed to display information to the user relevant to his or her inquiry or search, and function on more than one computer architecture, operating system, application software, application programming interface (API), web application, etc. It will be appreciated that computer program instructions used by systems described herein and/or the apps for use with the systems may include computer executable code in one of a variety of languages, including C, C++, Java, JavaScript, etc., and that all system components and system processors may be operatively coupled or associated with one another wirelessly, via hardware, software, and/or through cloud-based computing.

### User Interface

The present invention embodiments may employ any number of any type of user interface (e.g., Graphical User Interface (GUI), command-line, prompt, etc.) for obtaining or providing information (e.g., to receive a user's selection of publicly traded securities to monitor and to convey market data and alerts regarding the selected publicly traded securities to the user). The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

### Terminology/Definitions

As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration, but are not intended to be exhaustive or to limit the present invention to the embodiments disclosed. Many modifications and variations will be apparent to those of ordinary skill in the art without departing from the scope and spirit of the present invention. For example, while the alert classifier module is described as being implemented using a set of rules, it will be appreciated that it may be implemented as a machine learning model, such as a neural network trained to classify alerts using suitable training data (e.g., known combinations of alert factors and respective known classifications for the known combinations of alert factors). Additionally, while the client device has been described as obtaining market data directly from a market feed, it will be appreciated that the server may obtain market data from a market feed and provide it to the client device. It will also be appreciated that the machine learning model used to detect anomalies in online chatter may be re-trained periodically (e.g., daily) with more recent data (e.g., based on the previous x days of data, where x days preferably corresponds to several weeks of data). These and other modifications and variations are intended to be encompassed by the present disclosure.

What is claimed:

1. A system for alerting a user of an anomaly concerning a publicly traded financial product, comprising:
one or more processors; and
a memory storing instructions that, when executed by the one or more processors, cause the one or more processors to:
obtain online chatter from one or more social media platforms associated with the publicly traded financial product posted over a first time interval;
determine, at the end of the first time interval, an anomaly concerning the publicly traded financial product based at least in part on the online chatter associated with the publicly traded financial product; and
responsive to determining the anomaly, cause an alert to be provided to the user.

2. The system of claim 1, further comprising instructions stored in the memory that, when executed by the one or more processors, cause the one or more processors to obtain historical data regarding online chatter associated with the publicly traded financial product from a prior time interval before the first time interval; and
wherein the determination of the anomaly is based at least in part on the historical data.

3. The system of claim 2, wherein the determination of the anomaly is based at least in part on comparing a number of posts in the online chatter associated with the publicly traded financial product over the first time interval with a threshold determined using the historical data.

4. The system of claim 3, wherein the threshold is determined, at least in part, by feeding the historical data into a first machine learning model trained to determine an average and a standard deviation of a number of posts in the online chatter over the prior time interval in the historical data.

5. The system of claim 4, wherein the determination of the anomaly is based at least in part on the number of posts in the online chatter associated with the publicly traded financial product over the first time interval exceeding a threshold comprising a sum of the average number of posts and a multiple of the standard deviation.

6. The system of claim 1, wherein the first time interval is a period of time during a single trading day, and wherein the determination of the anomaly is based at least in part on whether the number of posts in the online chatter associated with the publicly traded financial product over the first time interval exceeds, by a predetermined percentage, an average number of posts during a same period of time over a number of previous trading days.

7. The system of claim 1, wherein causing an alert to be provided comprises:
obtaining metadata regarding the online chatter in the first time interval;
feeding the metadata regarding the online chatter in the first time interval into a machine learning model trained to output a prediction whether or not a price of the publicly traded financial product will move more than a predetermined amount based on training data comprising a set of known metadata and known amounts of price movement corresponding to the known metadata;
generating, via the machine learning model, a prediction whether or not a price of the publicly traded financial product will move more than a predetermined amount.

8. The system of claim 7, wherein the set of known metadata comprises one or more selected from the group consisting of (i) an average number of posts made by each poster every day for a previous number of days, (ii) an average number of followers of each poster at a time when the anomaly is determined, (iii) whether market data for the publicly traded financial product was available when the anomaly was determined, (iv) a lowest price of the publicly traded financial product during the first time interval, and (v) a difference between a highest price and the lowest price of the publicly traded financial product during the first time interval.

9. The system of claim 1, wherein the alert comprises at least one selected from the group comprising a visual alert and an audio alert.

10. The system of claim 1, wherein causing an alert to be provided comprises classifying the anomaly as one of a plurality types of anomaly, and wherein the alert is configured to be indicative of the classification.

11. The system of claim 1, further comprising instructions stored in the memory that, when executed by the one or more processors, cause the one or more processors to display a graphical user interface, and wherein the alert is displayed alongside market data for the publicly traded financial product in the graphical user interface.

12. The system of claim 1, further comprising instructions stored in the memory that, when executed by the one or more processors, cause the one or more processors to feed the online chatter over the first time interval into a large language model trained to provide a summary of online chatter, and wherein a summary of the online chatter over the first time interval generated by the large language model is provided to the user with the alert.

13. A method for alerting a user of an anomaly concerning a publicly traded financial product, comprising:
obtaining, with a computer, online chatter from one or more social media platforms associated with the publicly traded financial product posted over a first time interval;
determining, with the computer, at the end of the first time interval, an anomaly concerning the publicly traded financial product based at least in part on the online chatter associated with the publicly traded financial product; and
responsive to determining the anomaly, causing, with the computer, an alert to be provided to the user.

14. The method of claim 13, further comprising
obtaining, with the computer, historical data regarding online chatter associated with the publicly traded financial product from a prior time interval before the first time interval,
wherein the determination of the anomaly is based at least in part on the historical data.

15. The method of claim 14, wherein the determination of the anomaly is based at least in part on comparing, with the computer, a number of posts in the online chatter associated with the publicly traded financial product over the first time interval with a threshold determined using the historical data.

16. The method of claim 15, wherein the threshold is determined, at least in part, by feeding, with the computer, the historical data into a first machine learning model trained to determine an average and a standard deviation of a number of posts in the online chatter over the prior time interval in the historical data.

17. The method of claim 13, wherein the determination of the anomaly is based at least in part on the number of posts in the online chatter associated with the publicly traded security over the first time interval exceeding a threshold comprising a sum of the average number of posts and a multiple of the standard deviation.

18. A computer program product comprising a non-transitory computer-readable medium storing instructions thereon that, when executed by one or more processors, causes the one or more processors to:
obtain online chatter from one or more social media platforms associated with the publicly traded financial product posted over a first time interval;
determine, at the end of the first time interval, an anomaly concerning the publicly traded financial product based at least in part on the online chatter associated with the publicly traded financial product; and
responsive to determining the anomaly, cause an alert to be provided to the user.

19. The computer program product of claim 18, wherein the first time interval is a period of time during a single trading day, and wherein the determination of the anomaly is based at least in part on whether the number of posts in the online chatter associated with the publicly traded financial product over the first time interval exceeds an average number of posts during a same period of time over a number of previous trading days

20. The computer program product of claim 18, wherein causing an alert to be provided comprises:
obtaining metadata regarding the online chatter in the first time interval;
feeding the metadata regarding the online chatter in the first time interval into a machine learning model trained to output a prediction of whether or not a price of the publicly traded financial product will move more than a predetermined amount based on training data comprising a set of known metadata and known amounts of price movement corresponding to the known metadata;
generating, via the machine learning model, a prediction whether or not a price of the publicly traded financial product will move more than a predetermined amount.
